(19) United States
(12) Patent Application Publication
(10) Pub. No.: US 2011/0307269 A1
(43) Pub. Date: Dec. 15, 2011

(54) System and method for health-care continuities and vigilances

(76) Inventor: Anuthep Benja-Athon, New York, NY (US)

(21) Appl. No.: 13/199,231

(22) Filed: Aug. 24, 2011

Related U.S. Application Data
(63) Continuation-in-part of application No. 13/134,139, filed on May 31, 2011.
Application No. 13/134,139 is a continuation-in-part of application No. 13/065,518, filed on Mar. 24, 2011.
Application No. 13/065,518 is a continuation-in-part of application No. 12/924,054, filed on Sep. 20, 2010.
Application No. 12/924,054 is a continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00

(52) U.S. Cl. 705/2

(57) ABSTRACT

A system and method for applying diverse constellations and continua of clinical and medical algorithms and sequences, orders and arrays of related diagnoses and syndromes and related relational information and data on health and health-care and related diseases, disorders and illnesses related to patients and physicians in the viewing screens for delivering health-care continuities and vigilance and preventive medicine for and among physicians and patients by said network or networks of servers and computers, physicians and patients.

This application is a continuation-in-part of Ser. No. 13/134,139 entitled Brains-Server Synapses-Empowered Networking filed May 31, 2011, a continuation-in-part of Ser. No. 13/065,518 entitled Brains-empowered networking filed Mar. 24, 2011, a continuation-in-part of Ser. No. 12/924,054 entitled A server-guidance of health-care I filed Sep. 20, 2010, a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

The cloud-computing system and method for structuring and delivering health-care continuities and vigilance and preventive medicine to and among billions of people.

### BACKGROUND OF THE INVENTION

It is the present invention to which all health and health-care for billions of humans afflicted by diseases, disorders, illnesses and mortality are based on for millenniums to come.

All current, status quo brick-and-mortar health-care systems enabled physicians to diagnose and treat individual diseases, disorders and illnesses of individual patients as individual diseases, disorders and illnesses occurred or are presented to said physicians. Said archaic brick-and-mortar health-care systems lack the unique and innovative technological and logistic know-how and means for executing and achieving supra.

In other words, physicians treat diseases, disorders and illnesses presented to them by individual patients and not, most effectively and efficiently according to the present invention, individual entire humans from birth to death and, best yet, not individual diverse constellations and continua of occurrences, causes, developments, progressions and events of inter-related individual acute, subacute and/or chronic diseases, disorders, illnesses or syndromes and infections afflicting individual groups of thousands of humans or individual groups of millions humans in different and diverse settings, circumstances, localities, geographies and time, etc.

The health and illnesses of individual patients and individual groups of patients in different and diverse settings, circumstances, localities, etc. are not individual diseases, disorders, illnesses and/or infections but, by nature, are individual diverse constellations and continua of occurrences, causes, developments, progressions and events of inter-related individual acute, subacute and/or chronic diseases, disorders, illnesses or syndromes and infections and their biological, physiological and pathological idiosyncracies and attributes affecting the organ systems of said individual patients.

To further complicate said matters and events, said biological, physiological and pathological idiosyncracies and attributes affect said individual continua in said people are further, however, modified by the diversities of and variabilities in the human genes and the environments and circumstances wherein dwelled said people. Therefore, modifications and variations in and permutations of said individual continua commonly and continue to develop, arise and exist and are immense. Supra heretofore neither can be humanly managed nor achieved by physicians nor any health-care systems and technologies heretofore known to humankind.

The present invention is the unique and most innovative health-care cloud-computing system and method for achieving and providing means and solutions for supra and for uniquely and optimally executing and achieving the comprehensive and total health-care continuities, vigilance and preventive medicine for and among individual patients and groups of patients as whole in health and acute, subacute and chronic sicknesses—transcending the confines and definitions of individual humans, medical and surgical specialties, geographical boundaries and time—for, by and among billions of people including American and international physicians using computer servers and computers, laptops, computer tablets and mobile and wireless communication devices henceforth devices in said cloud computing.

Therefore, all humans in different and diverse settings, circumstances, localities, etc. are optimally and ideally managed, cared and treated as individual continua related to related diseases, disorders and illnesses including infections and environmental matters and events affecting the health, morbidity and mortality of said humans and related health-care continuities, vigilance and preventive medicine by and among physicians in different and diverse settings, circumstances, localities, etc. in said network or networks of computer servers, devices and said humans.

### SUMMARY OF THE INVENTION

The present invention provides and effects a fundamental system and method for providing, effecting and perpetuating individual continua of relational information and data related to patients and physicians in the viewing screens of computers and servers and teleconferencing platforms for executing, effecting and achieving health-care continuities, vigilance and preventive medicine for and among millions of patients and health-care providers in diverse localities, settings and circumstances.

Said diverse constellations and continua of clinical and medical algorithms and sequences, orders and arrays of related diagnoses and syndromes and related relational information and data on health and health-care and related diseases, disorders and illnesses—as described infra—related to patients and physicians in the viewing screens for delivering health-care continuities and vigilance and preventive medicine for and among physicians and patients by said network or networks of servers, computers, platforms, physicians and patients.

Consequently, the present invention provides unique and most innovative system of health-care and medicine wherein the best health, health-care and health-care services are most easily provided and achieved by and among billions of people in said network or networks.

### DESCRIPTION OF THE PREFERRED EMBODIMENTS

The present invention provide a system and method for continually delivering health-care continuities and vigilance and preventive medicine for individual patients, groups of patients and physicians by and among computer servers, computers, laptops, computer tablets, mobile and wireless communication devices henceforth devices, physicians and patients using said devices in said system comprising a network or networks of said servers, devices, physicians and patients. Said physicians and patients using said devices are able to view and interact with individual continua of SQL relations of first adaptable SQL information and data related to patients and physicians and related second adaptable SQL information and data related to individual patients and physicians in said SQL databases adaptable to be displayed in said viewing screens and platforms for delivering health-care continuities and vigilance and preventive medicine for and among individual patients, groups of patients and physicians in said network or networks of computer servers, devices and teleconferencing and video conferencing platforms henceforth platforms.

The present invention provides said functioning and operating computer servers including virtual servers comprising a plurality of processor units, memories, server operating system, said devices, SQL Server, computer scripting languages, html, various commercially available hardware including, but not limited to, routers, switches, modems and commercial and computer programs and software and source codes for enabling and effecting the networking and processes in the present invention, push, pull, file sharing and streaming technologies and a networking capability for networking said computer servers, devices and teleconferencing platforms including video conferencing henceforth platforms and networking capability for technologically pushing, pulling, forwarding, disseminating, sharing and streaming relational information and data on health and health-care by and among said servers, devices and platforms in said networks and, coupled to said hardware and software, the innovative computer programs and software including stored procedures means for generating SQL databases and instructing, commanding and causing said processor units and memories to repetitively and continually delivering health-care continuities and vigilance and preventive medicine for, between and among said physicians and patients in diverse and different settings, circumstances and locations, geographies and time and for instantly and continually communicating, disseminating and technologically pushing, pulling, streaming and sharing said relational information and data on diagnoses, diseases and illnesses and related information and data for, among and between people in said network or networks.

The system, method and means for generating relational information and data on health, health-care and health-care services in various types of interactive and versatile templates and submitting said relational information and data to said processor units and memories and SQL databases in and manage by said SQL Server by people using said devices in said network and networks are well taught in said pending or abandoned patent applications and their mother applications.

Said innovative computer programs and software including stored procedures means for generating said SQL databases and instructing, commanding and causing said processor units and memories to repetitively and continually perform the system and method for delivering health-care continuities and vigilance and preventive medicine can be extrapolated from said system, method and processes infra. Said logics applied to the SQL databases of the present invention and their derivatives.

Therefore, consequent to said the system, method and means, the present invention provides for said innovative computer programs and software including stored procedures means for generating, expanding and improving first adaptable SQL information and data comprising relations and compilations of related diagnoses and/or syndromes including synonyms, acronyms and equivalences and related signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories or categories and related to individual acute, subacute or chronic diseases, disorders and/or illnesses including acute, subacute and chronic infections and related sources, epidemiologies, chronologies and time-courses, occurrences, causes, developments, progressions, events and physiological, immunological and clinical processes and responses and related clinical and biological processes, patterns, trends, complications, risks, sequelae henceforth human illnesses and related adaptable clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related to individual medical and/or surgical specialties related to SQL keys in said SQL databases in and manage by said SQL Server adaptable to be continually displayed in said viewing screens of and among said devices and servers and platforms being used by and among patients and physicians according to said innovative computer programs and software.

Further to supra, the present invention provides for said innovative computer programs and software including stored procedures means for repetitively and continually generating second adaptable SQL information and data comprising individual categories and/or individual diagnoses or syndromes or individual groups of diagnoses and/or syndromes and related categories related to individual groups of related diagnoses and/or syndromes and related categories and, if related, related human illnesses and genetics related to individual patients and physicians in said SQL databases adaptable to be related and compiled with said first adaptable SQL information and data in said SQL databases in and manage by said SQL Server and continually displayed in said viewing screens of and among said devices and servers and platforms being used by and among individual patients and physicians.

Further to supra, consequently, the present invention provides for said innovative computer programs and software including stored procedures SQL relations of said first adaptable SQL information and data and related said second adaptable SQL information and data in said SQL databases in and manage by said SQL Server adaptable to be ordered and displayed as individual continua of said SQL relations of said first adaptable SQL information and data and related second adaptable SQL information and data which are viewed as clinical and medical algorithms and clinically logical sequences and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians. By and in said network or networks, the present invention provide a system and method for said innovative computer programs and software and, Web browsers, Web server and commercial programs and software for technologically and continually pushing, pulling, forwarding, disseminating, sharing and streaming data to technologically push, pull, forward, disseminate, share and stream said SQL relations of related said individual categories and, if related, related individual said human illnesses, and if related, related individual said genetics and related diagnoses and syndromes related to patients and physicians in said first SQL information and data in said SQL databases as said individual continua comprehensible by and interactive with and responsive to patients and physicians in said viewing screens of said devices and platforms being used by and among billions of patients and physicians.

To achieve the goals and objectives of the present invention, said innovative computer programs and software instruct and cause said processor units and memories to compile and generate said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians comprises:

Said innovative computer programs and software instruct and cause said processor units and memories to generate and compile said relations of related said individual categories and, if related, related individual said human illnesses, and if related, related individual said genetics related to related diagnoses and syndromes and related health-care continuities, vigilance and preventive medicine related to patients and physicians in said first SQL information and data in said SQL databases adaptable to be displayed as clinical and medical algorithms and clinically logical sequences, orders and arrays of said related categories and, if related, related human illnesses and/or related genetics and related clinical reasons and clinically ordered and structured presentations, documents, illustrations and arguments supporting said algorithms and sequences and arrays related to related diagnoses and syndromes and comprehensible by and interactive with and responsive to patients and physicians in said viewing screens of said devices and platforms being used by and among patients and physicians;

Said innovative computer programs and software instruct and cause said processor units and memories to generate and compile relations of related diagnoses and syndromes and related said individual categories and, if related, related individual said human illnesses, and if related, related individual said genetics related to health-care continuities, vigilance and preventive medicine related to patients and physicians in said first SQL information and data in said SQL databases adaptable to be displayed as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among patients and physicians; and

To achieve the goals and objectives of the present invention, further more, said innovative computer programs and software instruct and cause said processor units and memories to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians by said innovative computer programs and software to cause said processor units and memories to generate:
i. relations and compilations of related said individual categories and, if related, related to individual said human illnesses, and if related, related to individual said genetics related to diagnoses and syndromes including synonyms, acronyms and equivalences related to patients and physicians and outputting said relations and compilations to, to be related and compiled in said first SQL information and data in said SQL databases;
ii. repetitively scan and check said individual categories or individual diagnoses or syndromes with said second SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as second SQL information and data to and to be related and compiled with said first adaptable SQL information and data in and among said SQL tables in said SQL databases adaptable to be continually displayed in said viewing screens of and among said devices and servers and platforms being used by and among patients and physicians; and
iii. repetitively and continually scrutinize or scan and check individual said second SQL information and data with said first adaptable SQL information and data and match said second adaptable SQL information and data with same, similar or equivalent said individual categories and/or individual diagnoses and/or syndromes and/or individual groups of diagnoses and/or syndromes in said first adaptable SQL information and data wherein said individual outcomes of said individual scrutinies, scans, checks and matches are continually outputted to and related and compiled in and among said SQL tables in said first adaptable SQL databases adaptable to be displayed in said viewing screens of and among said devices and servers and platforms being used by and among patients and physicians.

First SQL Information and Data in Said SQL Databases

Appearing at any time in said viewing screens of said devices being used by billions of patients and physicians, one of the preferred embodiments of the present invention made possible only by said innovative computer programs and software including stored procedures coupled to said hardware and software and consequent to said processes of the present invention and the teachings of said pending or abandoned patent applications and their mother applications, there are immense SQL compilations and relations of SQL relations of tens of thousands of diagnoses and syndromes including synonyms, acronyms and equivalences—many of which are related and/or inter-related in said SQL databases—and, related to said tens of thousands of diagnoses and syndromes, there are even more immense SQL relations—in the orders of billions—of inter-related categories and said related human illnesses and related genetics and said related in said expanding and improving first adaptable SQL information and data in said SQL databases manage by said SQL Server.

Said innovative computer programs and software instruct and cause said processor units and memories to compile and generate individual continua of said relations and inter-relations which appear as adaptable clinical and medical algorithms and clinically logical sequences, orders and arrays and clinical and biological deviations including errors, mistakes, irregularities, illogics, complications, risks and sequelae and related clinical reasons and clinically ordered and structured presentations, documents, illustrations and arguments supporting said algorithms and sequences and arrays related to millions or billions of patients and physicians and comprehensible by and interactive with and responsive to said patients and physicians in said viewing screens of said devices and platforms being used by and among said billions individual patients, patients and physicians.

One of the preferred embodiments of the present invention, said process for said innovative computer programs and software and, Web browsers, Web server and commercial programs and software for technologically pushing, pulling, forwarding, disseminating, sharing and streaming said information and data to technologically push, pull, forward, disseminate, share and stream said millions or billions of SQL relations of related said individual categories and/or related said individual diagnoses and/or syndromes and/or related diagnoses and syndromes including synonyms, acronyms and equivalences, and, if related, related individual said human illnesses, and if related, related individual said genetics and related diagnoses and syndromes related to patients and physicians in said first SQL information and data in said SQL databases as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among said patients and physicians.

A few examples infra serves to explain said one preferred embodiment of many of the present invention.

In addition to supra, a few embodiments—briefly explained infra—representing the preferred embodiments of the present invention provide processes for said innovative computer programs and software to instruct and cause said processor units and memories and enabled by said Web browsers, Web server and commercial programs and software for technologically pushing, pulling, forwarding, disseminating, sharing and streaming billions of said relational information in said network or networks to automatically and continually update, adapt and improve successive compilations of said first adaptable SQL information and data—and, consequently, said expanding and improving said second adaptable SQL information and data in said SQL databases adaptable to be displayed in said viewing screens in said devices and platforms and being interactive and responsive to and among billions of patients and physicians.

Second SQL Information and Data Related to Said First SQL Information and Data in Said SQL Databases

One of the preferred embodiments of the present invention, said process for said innovative computer programs and software to instruct and cause said processor units and memories to repetitively and continually scan and check submitted to said processor units and memories by said physicians and/or patients using said devices and/or platforms:
i. said individual categories or individual diagnoses or syndromes submitted by said individual physicians or individual group of physicians with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data related to and compiled with said first SQL information and data in said SQL databases;
ii. said individual categories or individual diagnoses or syndromes submitted by said individual physicians or individual group of physicians with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data related to and compiled with said first SQL information and data in said SQL databases;
iii. said individual categories or individual diagnoses or syndromes submitted by said individual patients and/or individual physicians or individual group of physicians with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data related to and compiled with said first SQL information and data in said SQL databases and
a process for said innovative computer programs and software to cause said processor units and memories to generate relations of individual categories in patients' languages related to individual patients and physicians or individual group of physicians submitted by said individual patients and/or individual physicians or individual group of physicians using said devices to said processor units and memories;
iv. said individual categories or individual diagnoses or syndromes submitted by said individual patients and/or individual physicians or individual group of physicians with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data related to and compiled with said first SQL information and data in said SQL databases and
a process for said innovative computer programs and software to cause said processor units and memories to generate relations of individual categories in patients' languages related to individual patients, individual groups of patients and physicians or individual group of physicians submitted by said individual patients and/or individual physicians or individual group of physicians using said devices to said processor units and memories; etc.

Said innovative computer programs and software continually instruct and cause said processor units and memories to compile and generate said second SQL information and data related said first adaptable first SQL information and data in said SQL databases and display as said individual continua being used by and among said millions or billions individual patients, patients and physicians.

In addition to supra, another of the preferred embodiments of the present invention, said innovative computer programs and software instruct and cause said processor units and memories to repetitively and continually scrutinize or scan and check individual relations in said second SQL information and data related to individual patients and physicians in said SQL databases with same, similar or equivalent SQL information and data related to thousands or millions of patients and physicians in said first SQL information and data in said SQL databases wherein said individual outcomes of said individual scrutinies or scan and checks are continually outputted as supra as said second SQL information and data related to and compiled with said expanding and improving first adaptable SQL information and data in said SQL databases. Consequently, said innovative computer programs and software and various commercial programs and software, Web browsers, Web server and computer software for technologically pushing, pulling, forwarding, disseminating, sharing and streaming said outcomes of said processes to be technologically and continually push, pull, forward, disseminate, share and stream said second adaptable SQL information and data related to said first adaptable SQL information and data as individual continua comprehensible by and interactive with and responsive to said individual patients and physicians in said viewing screens of said devices and platforms being used by and among individual patients and physicians.

In other words, said preferred embodiment of the present invention, said innovative computer programs and software continually instruct and cause said processor units and memories to repetitively and continually or 24/7 scrutinize or scan and check to improve not only the adaptable and expanding medical and clinical records comprising said minimal information and data related to individual patients generated and submitted—as taught by said pending patent applications and their mother applications—represented as said second adaptable SQL information and data in said SQL databases by said individual patients and physicians but also to provide, effect, secure and deliver health-care continuities and vigilance and preventive medicine for said individual patients and physicians by providing second adaptable SQL information and data related to said first adaptable SQL information and data as individual continua comprehensible by and interactive with and responsive to said individual patients and physicians in said viewing screens of said devices and platforms being used by and among individual patients and physicians. Said preferred embodiment of the present invention server-automatically and continually apply to millions or billions of said second adaptable SQL information and data in said SQL databases, thus, uniquely fulfilling one of the objectives and goals of the present invention.

In addition to supra, yet another one of the preferred embodiments of the present invention, said processes automatically and continually improve or optimize individual first adaptable SQL information and data related to millions of patients and physicians and related individual second adaptable SQL information and data related to billions of individual patients and physicians in said network or networks, said preferred embodiment of the present invention comprises:
i. said process for said network or networks to continually execute and achieve health-care continuities and vigilance and preventive medicine for and among individual patients and groups of patients and physicians by and among said computer servers, devices, physicians and patients;
ii. said process for displaying said individual outcomes and related relations of said individual scans, checks and matches, scrutinies, scans and checks by said processor units and memories, Web server and Web browsers in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians; and
iii. a process for said innovative computer programs and software to instruct and cause said processor units and memories to automatically and continually update, adapt, improve or optimize successive relations and compilations of said first adaptable SQL information and data to which related said second adaptable SQL information and data are automatically and continually scrutinized, scanned, checked and matched by said processor units and memories and related relations are outputted as second SQL information and data to and to be related and compiled with said first adaptable SQL information and data in and among said SQL tables in said SQL databases adaptable to be continually displayed in said viewing screens of and among said devices and servers and platforms being used by and among patients and physicians.

In addition to supra, yet another one of the preferred embodiments of the present invention provides process for said innovative computer programs and software to instruct and cause said processor units and memories to automatically and continually update, adapt and improve successive compilations of said first adaptable SQL information and data in said SQL databases adaptable to be displayed in said viewing screens in said devices and platforms being used by and among billions of patients and physicians comprises:
said process for said innovative computer programs and software to instruct and cause said processor units and memories to repetitively scan and check said individual categories related to individual patients and physicians with said relational information and data in and among said related SQL tables and repetitively match said individual categories with same, similar or equivalent individual categories related to individual diagnoses or syndromes related to individual groups of related diagnoses and/or syndromes and related categories related to patients and physicians wherein said individual outcomes of said individual matches and related relations are continually related and compiled in said SQL databases and for said innovative computer programs and software, Web browsers, Web server and computer software for technologically pushing, pulling, forwarding, disseminating, sharing and streaming said outcomes of said processes among said devices and servers to cause said outcomes related to patients and physicians of said processes to be technologically and continually push, pull, forward, disseminate, share and stream in said viewing screens and platforms wherein said outcomes are interactive with, editable and adaptable by and among said patients and physicians using said devices;
said process for said innovative computer programs and software to instruct and cause said processor units and memories to repetitively scan and check said individual diagnoses related to individual patients and physicians with said relational information and data in and among said related SQL tables and repetitively match said individual diagnoses with same, similar or equivalent individual diagnoses related to individual diagnoses or syndromes and related categories related to individual groups of related diagnoses and/or syndromes and related categories related to patients and physicians wherein said individual outcomes of said individual matches and related relations are continually related and compiled in said SQL databases and for said innovative computer programs and software, Web browsers, Web server and computer software for technologically pushing, pulling, forwarding, disseminating, sharing and streaming said outcomes of said processes among said devices and severs to cause said outcomes related to patients and physicians of said processes to be technologically and continually push, pull, forward, disseminate, share and stream in said viewing screens and platforms wherein said outcomes are interactive with, editable and adaptable by and among said patients and physicians using said devices;
said process for said innovative computer programs and software to instruct and cause said processor units and memories to repetitively and continually scrutinize or scan and check individual adaptable relations of second SQL information and data with first adaptable SQL information and data comprising said individual diagnoses or syndromes and related categories related to individual groups of related diagnoses and/or syndromes and related categories related to individual groups patients and individual groups of physicians in said SQL databases wherein said individual outcomes of said individual scrutinies or scan and checks are continually related and compiled in said SQL databases and displayed in said viewing screens of and among said devices and servers and platforms being used by and among patients and physicians;
said process for said innovative computer programs and software, Web browsers, Web server and computer software for technologically pushing, pulling, forwarding, disseminating, sharing and streaming said second adaptable SQL information and data and related said first adaptable SQL information and data in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians which are interactive with and responsive to patients and physicians in said viewing screens of said devices and platforms being used by and among individual patients, patients and physicians for repetitively and continually updating, adapting and improving successive versions of SQL relations of said SQL information and data in and among said SQL tables in said SQL databases; and
a process for said innovative computer programs and software to instruct and cause said processor units and memories to repetitively and continually relate and compile said edited and adapted second adaptable SQL information in said first adaptable SQL information and data in said SQL databases.

1. A schematic example of millions of examples consequent to said second SQL information and data related to said first said second SQL information and data in and among said SQL databases consequent to said representative preferred embodiments of the present invention. A physician submitted a “expanding erythema migrans” simplistically and briefly representing a sign in said individual categories observed on an individual patient and submitted to said processor units and memories which is processed to said SQL databases and viewed on said viewing screens by said individual patient and physician and related authorized physicians as taught by said pending and abandoned patent applications and their mother applications. Said expanding erythema migrans submitted by said individual physicians is scanned and checked with said first SQL adaptable information and data in and among said SQL tables and repetitively match said sign with same, similar or equivalent signs related to individual diagnoses or syndromes related to individual groups of related diagnoses and/or syndromes and related categories wherein the individual outcome of said individual matches and related relations are outputted as said second SQL information and data related to and compiled with said first SQL information and data in said SQL databases and displayed as a representative individual continuum—of millions or billions of continua—as described supra as follows:

Representative Continuum 1—serving in said second adaptable information and data in said SQL relations related to said individual patient and related physicians in said SQL databases in and manage by said SQL Server as taught supra by said pending patent applications:

Lyme disease stage 1—current illness of said individual patient related to said physician who view and interacting with data infra using said devices and platforms in said network or networks: localized infection; expanding erythema migrans; red erythematous warm indurated vesicular necrotic annular macule; papule; rash thigh; rash groin; rash axilla; Lyme borreliosis; deer-tick bite; Eastern United States
interactive clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays in at least a plurality of interactive pop-up and/or drop-down lists and/or menus of words, terms, phrases, sentences, texts, synonyms, acronyms, texts, numbers, graphics, illustrations, pictures and word and term headers or headings adaptable to be displayed in comprehensible by and interactive with and responsive to patients and physicians in said viewing screens of said devices and servers and platforms being used by and among individual patient and physician or physicians in said network or networks;
said bold words, terms and phrases briefly represent said preferred embodiments as described in said first SQL information and data in said SQL databases.

Related to individual acute infectious disease are the following said human illnesses related to subacute and chronic infections and diseases and related diagnoses and/or syndromes and related said individual categories—including related and inter-related categories not shown herein as it is so vast and complex algorithms, sequences, orders and arrays achievable and doable only by said innovative computer programs and software and said related—and related sources, epidemiologies, chronologies and time-courses, occurrences, causes, developments, progressions, events and physiological, immunological and clinical processes and responses and related clinical and biological processes, patterns, trends, complications, risks, sequelae in related adaptable clinical and medical algorithms and clinically logical sequences and arrays and—not shown clinical and biological deviations including errors, mistakes, irregularities, illogics—complications, risks and sequelae related individual diagnosis on said individual disease and—not shown related genetics and related complications, risks, sequelae—related to said individual patient untreated:

Lyme disease stage 2—months from said acute phase:

disseminated infection; secondary red erythematous indurated vesicular necrotic annular macule; papule; rash; severe headache; neck stiffness; fever; chills; malaise; lethargy; fatigue; migratory musculoskeletal pain; arthralgias; muscle pain; bone pain; tendinitis; bursitis; lymphadenopathy; testicular swelling; hepatitis; splenomegaly; sore throat; nonproductive cough; rapidly progressive; multifocal pneumonia; conjunctivitis; iritis; meningeal irritation; meningitis; encephalitic signs; cranial neuritis; facial palsy; increased intracranial pressure; optic nerve compression; blindness; peripheral radiculopathy; motor; sensory; radiculopathy; mononeuritis multiplex; cerebellar ataxia; myelitis; meningopolyneuritis; Bannwarth's syndrome; lymphocytic pleocytosis; radicular pain; cardiac conduction abnormalities; atrioventricular block; first-degree; second-degree; third-degree; atrioventricular heart block; Wenckebach; complete heart block; acute myopericarditis; chronic cardiomyopathy; left ventricular dysfunction; cardiomegaly; asymptomatic left ventricular dysfunction; syncope; pancarditis; myopericarditis;
interactive clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays in at least a plurality of interactive pop-up and/or drop-down lists and/or menus of words, terms, phrases, sentences, texts, synonyms, acronyms, texts, numbers, graphics, illustrations, pictures and word and term headers or headings adaptable to be displayed in comprehensible by and interactive with and responsive to patients and physicians in said viewing screens of said devices and servers and platforms being used by and among individual patient and physician or physicians in said network or networks; and
said bold words, terms and phrases briefly represent said preferred embodiments as described supra—but schematics are achievable and doable in cloud computing by said innovative computer programs and software as said individual continua in said viewing screens of and among said devices and servers and platforms being used by and among patients and physicians according to said innovative computer programs and software in said network or networks but impossible to provide herein as they immensely involve related and inter-related diagnoses and syndromes and related human illnesses and genetics in and related to said first SQL information and data related to said millions of patients and physicians in said SQL databases in and manage by said SQL Server—representing relation of said second SQL information and data to said first SQL information and data.

Lyme disease stage 3—months to years from supra:

late infection; large joint oligoarticular arthritic knee; small joint oligoarticular arthritic knee; arthritic knees; chronic neuroborreliosis; distal paresthesia; spinal radicular pain; polyneuropathy; demyelinating polyneuropathy; chronic central nervous system disorders; encephalomyelitis; leukoencephalitis; periventricular white matter lesions; subtle encephalopathy; memory deficits; mood; sleep disorders; spastic paraparesis; upper motoneuron bladder dysfunction; reddish-violaceous discolored; atrophic; sclerotic; acrodermatitis chronica atrophicans;
interactive clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays in at least a plurality of interactive pop-up and/or drop-down lists and/or menus of words, terms, phrases, sentences, texts, synonyms, acronyms, texts, numbers, graphics, illustrations, pictures and word and term headers or headings adaptable to be displayed in comprehensible by and interactive with and responsive to patients and physicians in said viewing screens of said devices and servers and platforms being used by and among individual patient and physician or physicians in said network or networks; and
said bold words, terms and phrases briefly represent said preferred embodiments as described supra—but schematics are achievable and doable in cloud computing by said innovative computer programs and software as said individual continua in said viewing screens of and among said devices and servers and platforms being used by and among patients and physicians according to said innovative computer programs and software in said network or networks but impossible to provide herein as they immensely involve related and inter-related diagnoses and syndromes and related human illnesses and genetics in and related to said first SQL information and data related to said millions of patients and physicians in said SQL databases in and manage by said SQL Server—representing relation of said second SQL information and data to said first SQL information and data.

2. A schematic example of millions of examples consequent to said second SQL information and data related to said first said second SQL information and data in and among said SQL databases consequent to said representative preferred embodiments of the present invention. A physician submitted a “Systemic lupus erythematosus” simplistically and briefly representing a diagnosis said related diagnoses and syndromes observed on an individual patient and submitted to said processor units and memories which is processed to said SQL databases and viewed on said viewing screens by said individual patient and physician and related authorized physicians as taught by said pending and abandoned patent applications and their mother applications. Said Systemic lupus erythematosus submitted by said individual physicians is scanned and checked with said first SQL adaptable information and data in and among said SQL tables and repetitively match said sign with same, similar or equivalent diagnosis including synonyms, acronyms and equivalences related to Systemic lupus erythematosus related to individual groups of related diagnoses and/or syndromes and related categories wherein the individual outcome of said individual matches and related relations are outputted as said second SQL information and data related to and compiled with said first SQL information and data in said SQL databases and displayed as a representative individual continuum—of millions or billions of continua—as described supra as follows:

Representative Continuum 2—serving in said second adaptable information and data in said SQL relations related to said individual patient and related physicians in said SQL databases in and manage by said SQL Server as taught supra by said pending patent applications:

Systemic lupus erythematosus—current illness of said individual patient related to said physician who view and interacting with data infra using said devices and platforms in said network or networks:

fever; fatigue; malaise; nausea; anorexia; diffuse abdominal pain; diarrhea; weight loss; lupus dermatitis; malar; discoid; vasculitis rash; urticaria;
interactive clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays in at least a plurality of interactive pop-up and/or drop-down lists and/or menus of words, terms, phrases, sentences, texts, synonyms, acronyms, texts, numbers, graphics, illustrations, pictures and word and term headers or headings adaptable to be displayed in comprehensible by and interactive with and responsive to patients and physicians in said viewing screens of said devices and servers and platforms being used by and among individual patient and physician or physicians in said network or networks;
said bold words, terms and phrases briefly represent said preferred embodiments as described in said first SQL information and data in said SQL databases.

Related to systemic lupus erythematosus supra are the following said human illnesses related to subacute and chronic phases of systemic lupus erythematosus and related diagnoses and/or syndromes and related said individual categories—including related and inter-related categories not shown herein as it is so vast and complex algorithms, sequences, orders and arrays achievable and doable only by said innovative computer programs and software and said related—and related sources, epidemiologies, chronologies and time-courses, occurrences, causes, developments, progressions, events and physiological, immunological and clinical processes and responses and related clinical and biological processes, patterns, trends, complications, risks, sequelae in related adaptable clinical and medical algorithms and clinically logical sequences and arrays and—not shown clinical and biological deviations including errors, mistakes, irregularities, illogics—complications, risks and sequelae related individual diagnosis on said individual disease and—not shown related genetics and related complications, risks, sequelae:

Systemic lupus erythematosus—months to years from supra according to said descriptions in said first SQL information and data in said SQL databases:

subacute cutaneous lupus; alopecia; photosensitivity rash; oral ulcers; nasopharyngeal ulcers; serositis; pleuritis; pleural effusion; interstitial inflammation; fibrosis; intraalveolar hemorrhage; pericarditis; atherosclerosis; lupus myocarditis; Libman-Sachs fibrinous endocarditis; myocardial infarction; arrhythmia; heart failure; arthritis; hemolytic anemia; leukopenia; lymphopenia; thrombocytopenia; lupus nephritis; nephrotic syndrome; hematuria; proteinuria; hypertension; end-stage renal disease; splenomegaly; abnormal liver enzymes; anti-dsDNA; anti-Sm; anti-phospholipid; antinuclear; antibodies;

intermittent polyarthritis; synovitis; deformities; hands; wrists; knees; feet; ischemic bone necrosis; myositis; myalgias; muscle inflammation; weakness; necrosis; vasculitis; venous arterial thrombosis; embolus;

headaches; aseptic meningitis; myelopathy; cognitive disorder; acute confusional state; mood disorder; seizures; psychosis; mononeuropathy; polyneuropathy; movement disorder; transient ischemic attacks; strokes;

conjunctivitis; episcleritis; sicca syndrome; vasculitis; retinal vasculitis; optic neuritis; blindness; autoimmne peritonitis; intestinal perforations, infarction; ischemia, bleeding; sepsis;
interactive clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays in at least a plurality of interactive pop-up and/or drop-down lists and/or menus of words, terms, phrases, sentences, texts, synonyms, acronyms, texts, numbers, graphics, illustrations, pictures and word and term headers or headings adaptable to be displayed in comprehensible by and interactive with and responsive to patients and physicians in said viewing screens of said devices and servers and platforms being used by and among individual patient and physician or physicians in said network or networks; and
said bold words, terms and phrases briefly represent said preferred embodiments as described supra—but schematics are achievable and doable in cloud computing by said innovative computer programs and software as said individual continua in said viewing screens of and among said devices and servers and platforms being used by and among patients and physicians according to said innovative computer programs and software in said network or networks but impossible to provide herein as they immensely involve related and inter-related diagnoses and syndromes and related human illnesses and genetics in and related to said first SQL information and data related to said millions of patients and physicians in said SQL databases in and manage by said SQL Server—representing relation of said second SQL information and data to said first SQL information and data.

Said preferred embodiment also applies to said individual categories or individual diagnoses or syndromes submitted by said individual patients and/or individual physicians or individual group of physicians with said SQL information and data in and among said SQL tables and repetitively and also applies to said individual categories or individual diagnoses or syndromes submitted by said individual patients and/or individual physicians or individual group of physicians.

Included in supra, a process for said innovative computer programs and software to cause said processor units and memories to generate relations of individual categories in patients' languages related to individual patients and physicians or individual group of physicians submitted by said individual patients and/or individual physicians or individual group of physicians using said devices to said processor units and memories.

Included in supra, a process for said innovative computer programs and software to cause said processor units and memories to generate relations of individual categories in patients' languages related to individual patients, individual groups of patients and physicians or individual group of physicians submitted by said individual patients and/or individual physicians or individual group of physicians using said devices to said processor units and memories.

In summary, said two representative continua schematically and simplistically represent said preferred embodiments of the present invention. Or course, in said continua in said viewing screens of said devices and platforms, the real continua—contrast to said simple and chaotic schematics—in said viewing screens will be appropriately colored, well-organized and well-presented clinical and medical algorithms and clinically logical sequences and arrays easily comprehensible and used by said people. Therefore, people in different and diverse settings, circumstances, events, localities, geographies, time, etc. are optimally and ideally managed, cared and treated as individual continua—number in millions related to said first SQL information and data and related said second SQL information and data—related to related diseases, disorders and illnesses including infections and environmental matters and events—as described in said first SQL information and data to which related said second SQL information and data—affecting the health, morbidity and mortality of said people and related health-care continuities, vigilance and preventive medicine by and among physicians in different and diverse settings, circumstances, localities, etc. in said network or networks of computer servers, devices, platforms and said people.

In addition to supra, yet another one of the preferred embodiments of the present invention comprises a process for said network or networks to continually execute and achieve health-care continuities and vigilance and preventive medicine for and among individual patients and groups of patients and physicians by and among said computer servers, devices, physicians and patients a process for said processor units and memories to repetitively and continually:
i. determine congruencies of and detect human illnesses and clinical and biological deviations including errors, mistakes, irregularities, illogics, complications, risks and sequelae in said SQL relations in individual second adaptable SQL information and data related to said SQL relations in said first adaptable SQL information and data adaptable to be displayed in said viewing screens of said devices and platforms being used by patients and physicians;
ii. determine redundancies and duplications in said SQL relations in individual second adaptable SQL information and data related to said SQL relations in said first adaptable SQL information and data adaptable to be displayed in said viewing screens of said devices and platforms being used by patients and physicians; and
iii. extrapolate and forecast clinical and medical trends, processes, risks, complications, errors, mistakes, consequences, sequelae, time-courses and morbidity and mortality in and related to said SQL relations in individual second adaptable SQL information and data related to said SQL relations in said first adaptable SQL information and data adaptable to be displayed in clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and servers and platforms being used by and among individual patients, patients and physicians.

In said processes, further to supra, as can be understood infra and taught in said 2011 pending patent applications of the present applicant, the present invention uses said teachings, first, a process for said innovative computer programs and software to instruct and cause said processor units and memories to process and “translate” said submitted individual categories in patients' languages into individual categories related to physicians which are integral components of health, health-care and health-care-service information and data on and related to patients being used by and among physicians of all and diverse medical and surgical practices or specialties for and in the communications of said information and data among physicians, and, second, a process for said innovative computer programs and software to cause said processor units and memories to automatically “translate” said outcomes of said processes into languages comprehensible by patients adaptable to be displayed as said individual continua of said relations and inter-relations in the viewing screens of said devices being used by and among said patients. Of course, for ease of understanding and writing, said “translate” used herein actually means, in the computer servers, to relate said submissions and outcomes related to patients and physicians as described herein to categories and related in said medical and surgical words, terms, phrases, sentences, etc. and in patients' languages, respectively, in said SQL databases by said processor units and memories according to said innovative computer programs and software. The consequences of said relations enabled said processor units and memories to fulfill the objectives and goals of the present invention as taught in said 2011 pending patent applications and herein.

Even though the present invention provides a process for said innovative computer programs and software and, Web browsers, Web server and commercial programs and software for technologically pushing, pulling, forwarding, disseminating, sharing and streaming to technologically push, pull, forward, disseminate, share and stream said SQL relations of said second adaptable SQL information and data related to individual patients and physicians and said first SQL information and data in said SQL databases, it is to be understood that said relational information and data and said clinical and medical algorithms and clinically logical sequences and arrays of said related diagnoses and syndromes and related categories and, if related, related human illnesses and/or related genetics and related clinical reasons and clinically ordered and structured presentations, documents, illustrations and arguments supporting said algorithms and sequences and arrays can be viewed and comprehended and interactive with and responsive to patients and physicians in the viewing screens of any and all said devices and platforms currently used by said people.

Said preferred embodiments including said individual continua in said cloud computing of the present invention provide and effects a fundamental innovative health-care system and method for providing, effecting, executing, achieving and perpetuating health-care continuities, vigilance and preventive medicine for and among billions of patients and health-care providers in diverse localities, geographies, settings and circumstances. Consequently, the present invention provides unique and innovative system of health-care and medicine wherein the best health, health-care and health-care services based on said preferred embodiments are most easily achieved by and among billions of people.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java script, AJAX, HTML, XHTML, Flash and video, a Microsoft IIS, Apache, a Web browser, Web server and possessing and operating the present applicant's invented innovative computer programs and software for commanding and communicating for commanding and communicating with said SQL Server and said relational database and/or databases and coupling with said computer scripting languages and said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, 2-dimensional and 3-dimensional representations of body parts, illustrations, figurines, graphics, pictures and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens.

The present invention provides said innovative computer programs and software invented by the present patent applicant which were filed with and are stored in the Library of Congress in Washington, D.C. The present invention uses also the commercially available computer software (plural), programs and computer languages such as, but not limited to, those made and sold by Adobe Systems, Inc. such as, but not limited to, Flash and Flash video and streaming technologies and Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML JavaScript, AJAX, HTML, .net, Wordpad, Notepad, .txt, Flash and video enabled programs and the like and related and their derivatives. Other computer programs and software also include application software (plural) also known as Applications or Apps for manipulating, texting, numbering, graphics, or any combinations of these elements for uses and applications with smartphones such as, but not limited to, iPhone and iPad of Apple, Inc. and Google's Android software in Google smartphones. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate.

It is to be understood that said computer servers of the present invention also further embodied any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer or computers in the claims infra may also implied computer server, computer servers, virtual server, virtual servers.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Further to supra, the present invention can incorporate, use and/or network with Skype—which was recently acquired by Microsoft Corp. in 2011 as Microsoft Skype Division and the like products and derivatives—to achieve the goals and objectives of the present invention.

However, the preferred embodiments of said pending patent applications supra and present invention and other pending applications of the present patent applicant motivated and caused the development and present implementation of clients-server system—all or almost all matters, events and communications of, by, among and between patients and physicians using said devices in USA and all over the world—are implemented and occurring in said network or networks of computer servers and virtual servers including push, pull, file sharing and streaming technologies using commercially available program and software, such as, but not limited to, the Comet technology being sold by several companies such as, LightStreamer—http://www.lightstreamer.com—and the like and their derivatives and related for technologically push and pull for streaming and disseminating and propagating said outcomes including real-time information and data as described in the preferred embodiments of the present invention to said devices and platforms and other computer servers if linked to said networks. Said preferred embodiments also motivate and cause the sooner implementations of teleconferencing and video conferencing in and to occur in the system of network or networks of computer servers and devices so claimed in the claims of the present invention infra and said pending patent applications. Furthermore, said teleconferencing and videoconferencing also include, but not limited to, multipoint videoconferencing, instant messaging and mobile instant messaging.

Although the present invention is a vital component of the Cloud Healthcare Exchange created and formed by various pending patent applications of and the innovative computer programs and software invented, created, matured and applied by of the present patent applicant coupled to various commercially available computer hardware and equipment and various computer programs and software and technologies, one of the preferred embodiments of the present invention provides human civilization with the networks of patients and physicians and computer servers, teleconferencing platforms including video conferencing henceforth platforms and computers, laptops, computer tablets such as, but not limited to, iPad of Apple, Touchpad of HP and the like of Samsung and HTC and hand-held, wireless and mobile communication devices and equipment—comprise keyboards and viewing screens including touch-enabled viewing screens or touch-screens and speech recognition technologies—enabled by Web browsers and said Web server in said network or networks for accessing and interacting with said servers and platforms henceforth devices being used by patients and physicians networked to said servers adaptable to technologically push, pull, forward, disseminate, share and stream relational information and data on health and health-care described herein. However, by default and the immensity of the present invention, clients to computer servers in said networks or cloud computing may depend on said push and pull as all events and matters and outcomes will occur and execute with said networks.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that the system and method taught by U.S. Pat. No. 6,132,218 entitled Images for communication of medical information in computer granted Oct. 17, 2000 to this present patent applicant will be incorporated into said preferred embodiments of the present invention to achieve the goals and objectives of the present invention.

It is to be understood that the present invention provides also voice-enabled means for interacting such as, but not limited to, speech recognition technology, Voice over Internet Protocol, IP telephony, Internet telephony, voice over broadband (VoBB), broadband telephony and broadband phone and near field communication in said preferred embodiments.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims and specification of the present invention.

1. A system for delivering health-care continuities and vigilance and preventive medicine for individual patients, groups of patients and physicians by and among computer servers, computers, laptops, computer tablets, mobile and wireless communication devices henceforth devices and teleconferencing platforms, physicians and patients using said devices and platforms in said system comprising a network or networks of said servers, devices, platforms, physicians and patients comprises:
said functioning and operating computer servers including virtual servers comprising a plurality of processor units, memories, server operating system, said devices, SQL Server, computer scripting languages, html, various commercially available hardware including, but not limited to, routers, switches, modems and commercial and computer programs and software and source codes for enabling and effecting the networking and processes in the present invention, push, pull, file sharing and streaming technologies and a networking capability for networking said computer servers, devices and teleconferencing platforms including video conferencing henceforth platforms and networking capability for technologically pushing, pulling, forwarding, disseminating, sharing and streaming relational information and data on health and health-care by and among said servers, devices and platforms in said networks and, coupled to said hardware and software, the innovative computer programs and software including stored procedures means for generating SQL databases and instructing, commanding and causing said processor units and memories to repetitively and continually delivering health-care continuities and vigilance and preventive medicine for, between and among said physicians and patients in diverse and different settings, circumstances and locations, geographies and time and for instantly and continually communicating, disseminating and technologically pushing, pulling, streaming and sharing said relational information and data on diagnoses, diseases and illnesses and related information and data for, among and between people in said network or networks;
first adaptable SQL information and data comprising relations and compilations of related diagnoses and/or syndromes including synonyms, acronyms and equivalences and related signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories or categories and related to individual acute, subacute or chronic diseases, disorders and/or illnesses including acute, subacute and chronic infections and related sources, epidemiologies, chronologies and time-courses and physiological, immunological and clinical processes and responses and related clinical and biological processes, patterns, trends, complications, risks, sequelae henceforth human illnesses and related adaptable clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related to individual medical and/or surgical specialties related to SQL keys in said SQL databases adaptable to be continually displayed in said viewing screens of and among said devices and servers and platforms being used by and among patients and physicians according to said innovative computer programs and software;
second adaptable SQL information and data comprising individual categories and/or individual diagnoses or syndromes or individual groups of diagnoses and/or syndromes and related categories related to individual groups of related diagnoses and/or syndromes and related categories and, if related, related human illnesses and genetics related to individual patients and physicians in said SQL databases adaptable to be related and compiled with said first adaptable SQL information and data in said SQL databases and continually displayed in said viewing screens of and among said devices and servers and platforms being used by and among individual patients and physicians;
SQL relations of said first adaptable SQL information and data and related said second adaptable SQL information and data in said SQL databases adaptable to be ordered and displayed as clinical and medical algorithms and clinically logical sequences and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians; and
individual continua of said SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians.

2. The system according to claim 1 wherein said individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians comprises:
said SQL relations of related said individual categories and, if related, related individual said human illnesses, and if related, related individual said genetics related to related diagnoses and syndromes and related health-care continuities, vigilance and preventive medicine related to patients and physicians in said first SQL information and data in said SQL databases adaptable to be displayed as clinical and medical algorithms and clinically logical sequences, orders and arrays of said related categories and, if related, related human illnesses and/or related genetics and related clinical reasons and clinically ordered and structured presentations, documents, illustrations and arguments supporting said algorithms and sequences and arrays related to related diagnoses and syndromes and comprehensible by and interactive with and responsive to patients and physicians in said viewing screens of said devices and platforms being used by and among patients and physicians;
said SQL relations of related diagnoses and syndromes and related said individual categories and, if related, related individual said human illnesses, and if related, related individual said genetics related to health-care continuities, vigilance and preventive medicine related to patients and physicians in said first SQL information and data in said SQL databases adaptable to be displayed as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among patients and physicians; and
SQL relations of said second adaptable SQL information and data related to individual patients and physicians and said first SQL information and data in said SQL databases adaptable to be displayed as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to individual patients and physicians in said viewing screens of said devices and platforms being used by and among individual patients and physicians.

3. In a system for delivering health-care continuities and vigilance and preventive medicine for individual patients, groups of patients and physicians by and among computer servers, computers, laptops, computer tablets, mobile and wireless communication devices henceforth devices and platforms, physicians and patients using said devices in said system comprising a network or networks of said servers, devices, platforms, physicians and patients, a method for executing and achieving health-care continuities and vigilance and preventive medicine for individual patients, groups of patients and physicians by and among said servers, devices, physicians and patients comprises:
a process for operating said functioning and operating said network or networks of said servers comprising said innovative computer programs and software including stored procedures and various commercial computer programs and software coupled to said processor units and memories and at least a Web server and devices and platforms comprising viewing screens including touch-screens and Web browsers being used by and among said physicians and patients;
a process for said innovative computer programs and software to cause said processor units and memories to generate first adaptable SQL information and data comprising relations and compilations of related diagnoses and/or syndromes including synonyms, acronyms and equivalences and related signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories or categories and related to individual acute, subacute or chronic diseases, disorders and/or illnesses including acute, subacute and chronic infections and related epidemiologies, chronologies and time-courses and physiological, immunological and clinical processes and responses and related clinical and biological processes, patterns, trends, complications, risks, sequelae henceforth human illnesses and related clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related to individual medical and/or surgical specialties by said patients and physicians using said devices to said processor units and memories which process relational information and data and output said relations and compilations to and to be related to SQL keys in said SQL tables in said SQL databases according to said innovative computer programs and software;
a process for said innovative computer programs and software to cause said processor units and memories to generate relations of individual categories related to individual patients and physicians or individual group of physicians submitted by said individual physicians or individual group of physicians using said devices to said processor units and memories;
a process for said innovative computer programs and software to cause said processor units and memories to generate relations of individual diagnoses or syndromes related to individual patients and physicians or individual group of physicians submitted by said individual physicians or individual group of physicians using said devices to said processor units and memories;
a process for said innovative computer programs and software to cause said processor units and memories to generate relations of individual categories in patients' languages related to individual patients and physicians or individual group of physicians submitted by said individual patients and/or individual physicians or individual group of physicians using said devices to said processor units and memories;
a process for said innovative computer programs and software to cause said processor units and memories to generate relations of individual categories in patients' languages related to individual patients, individual groups of patients and physicians or individual group of physicians submitted by said individual patients and/or individual physicians or individual group of physicians using said devices to said processor units and memories;
a process for said innovative computer programs and software including stored procedures to instruct and cause said processor units and memories to generate and compile said relational information and data in related SQL tables in said SQL databases;
a process for translating said submitted individual categories in patients' languages by said individual patients or individual groups of patients into individual categories related to physicians which are integral components of health, health-care and health-care-service information and data on and related to patients being used by and among physicians of all and diverse medical and surgical practices or specialties for and in the communications of said information and data by and among physicians by said processor units and memories;
a process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as second SQL information and data comprising individual categories and/or individual diagnoses or syndromes or individual groups of diagnoses and/or syndromes and related categories related to individual groups of related diagnoses and/or syndromes and related categories and, if related, related human illnesses and genetics related to individual patients and physicians in said SQL databases and to be related and compiled with SQL information and data in and among said SQL tables in said SQL databases and continually displayed in said viewing screens of and among said devices and servers and platforms being used by and among patients and physicians;
a process for said innovative computer programs and software to instruct and cause said processor units and memories to repetitively and continually scrutinize or scan and check individual adaptable relations of SQL information and data comprising individual diagnoses or syndromes and related categories related to individual groups of related diagnoses and/or syndromes and related categories related to individual patients and physicians in said SQL databases with same, similar or equivalent SQL information and data related to patients and physicians in said SQL databases wherein said individual outcomes of said individual scrutinies or scan and checks are continually displayed in said viewing screens of and among said devices and servers and platforms being used by and among patients and physicians;
a process for translating said outcomes of said processes into languages comprehensible by patients adaptable to be displayed in the viewing screens of said devices by said processor units and memories;
a process for said innovative computer programs and software instruct and cause said processor units and memories to repetitively and continually scrutinize or scan and check individual adaptable relations of said second SQL information and data related to individual patients and physicians in said SQL databases with same, similar or equivalent SQL information and data related to patients and physicians in said first SQL information and data in said SQL databases wherein said individual outcomes of said individual scrutinies or scans and checks are outputted as second SQL information and data related to and compiled with expanding and improving said first adaptable SQL information and data in said SQL databases;
a process for displaying said information and data and related individual outcomes and related relations of said individual scans, checks and matches, scrutinies, scans and checks by said processor units and memories, Web server and Web browsers in said viewing screens of said devices and platforms being used by and among individual patients, patients and physicians;
a process for said innovative computer programs and software to instruct and cause said processor units and memories to automatically and continually update, adapt and improve successive compilations of said first adaptable SQL information and data and adaptable SQL information and data in said SQL databases adaptable to be displayed in said viewing screens in said devices and platforms being used by and among patients and physicians;
a process for said network or networks to continually execute and achieve health-care continuities and vigilance and preventive medicine for and among individual patients and groups of patients and physicians by and among said computer servers, devices, physicians and patients; and
a process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians.

4. The method according to claim 3 wherein said process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data, first, comprises:
a process for said innovative computer programs and software to cause said processor units and memories to generate relations of individual categories related to individual patients and physicians or individual group of physicians submitted by said individual physicians or individual group of physicians using said devices to said processor units and memories;
a process for said innovative computer programs and software to cause said processor units and memories to scan and check said submitted individual categories with said relational information and data in and among said related SQL tables and repetitively match said submitted individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to physicians and patients adaptable to be continually displayed said matched and relations in said viewing screens of and among said devices and servers and platforms being used by and among patients and physicians;
a process for said innovative computer programs and software to cause said processor units and memories to scan and check said submitted individual categories with said relational information and data in and among said related SQL tables and repetitively match said submitted individual categories and individual diagnoses and syndromes with same, similar or equivalent with same, similar or equivalent individual categories related to individual diagnoses and/or individual syndromes related to said physicians related to individual groups of related diagnoses and/or syndromes and related categories and related acute, subacute and/or chronic infections and related chronologies and time-courses and immunological processes including responses henceforth human illnesses related to physicians and patients adaptable to be continually displayed said matched and relations in said viewing screens of and among said devices and servers and platforms being used by and among patients and physicians;
a process for said innovative computer programs and software to cause said processor units and memories to scan and check said submitted individual categories with said relational information and data in and among said related SQL tables and repetitively match said submitted individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to individual sequences or portions of DNA of human genome henceforth genetics related to physicians and patients adaptable to be continually displayed said matched and relations in said viewing screens of and among said devices and servers and platforms being used by and among patients and physicians;
a process for displaying said individual outcomes and related relations of said individual matches, scrutinies and scan and checks by said processor units and memories, Web server and Web browsers in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians;
a process for said innovative computer programs and software to cause said processor units and memories to automatically translate said outcomes of said processes into languages comprehensible by patients adaptable to be displayed in the viewing screens of said devices and platforms being used by and among said patients; and
a process for said innovative computer programs and software to cause said processor units and memories to automatically and continually improve or optimize said outcomes of said processes related to physicians and patients and output said outcomes to, to be related and compiled in said SQL databases adaptable to be displayed in said viewing screens in said devices and platforms being used by and among patients and physicians.

5. The method according to claim 3 wherein said process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data, second, comprises:
a process for said innovative computer programs and software to cause said processor units and memories to generate relations of individual diagnoses or syndromes related to individual patients and physicians or individual group of physicians submitted by said individual physicians or individual group of physicians using said devices to said processor units and memories;
a process for said innovative computer programs and software to cause said processor units and memories to scan and check said submitted individual diagnoses or syndromes with said relational information and data in and among said related SQL tables and repetitively match said submitted individual diagnoses or syndromes with same, similar or equivalent with same, similar or equivalent individual diagnoses or syndromes related to individual categories related to individual groups of related diagnoses and/or syndromes and related categories related to physicians and patients adaptable to be continually displayed said matched and relations in said viewing screens of and among said devices and servers and platforms being used by and among patients and physicians;
a process for said innovative computer programs and software to cause said processor units and memories to scan and check said individual diagnoses or syndromes with said relational information and data in and among said related SQL tables and repetitively match said individual diagnoses or syndromes with same, similar or equivalent with same, similar or equivalent individual diagnoses or syndromes related to individual categories related to individual groups of related diagnoses and/or syndromes and related categories and related human illnesses related to physicians and patients adaptable to be continually displayed said matched and relations in said viewing screens of and among said devices and servers and platforms being used by and among patients and physicians;
a process for said innovative computer programs and software to cause said processor units and memories to scan and check said individual diagnoses or syndromes with said relational information and data in and among said related SQL tables and repetitively match said individual diagnoses or syndromes with same, similar or equivalent with same, similar or equivalent individual diagnoses or syndromes related to individual categories related to individual groups of related diagnoses and/or syndromes and related categories and related genetics related to physicians and patients adaptable to be continually displayed said matched and relations in said viewing screens of and among said devices and servers and platforms being used by and among patients and physicians;
a process for displaying said individual outcomes of said individual matches and related relations by said processor units and memories, Web server and Web browsers in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians;
a process for said innovative computer programs and software to cause said processor units and memories to automatically translate said outcomes of said processes into languages comprehensible by patients adaptable to be displayed in the viewing screens of said devices being used by and among said patients; and
a process for said innovative computer programs and software to cause said processor units and memories to automatically and continually improve or optimize said outcomes of said processes related to physicians and patients and output said outcomes to, to be related and compiled in said SQL databases adaptable to be displayed in said viewing screens in said devices and platforms being used by and among patients and physicians.

6. The method according to claim 3 wherein said process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data, third, comprises:
a process for said innovative computer programs and software to cause said processor units and memories to generate relations of individual categories in patients' languages related to individual patients and physicians or individual group of physicians submitted by said individual patients and/or individual physicians or individual group of physicians using said devices to said processor units and memories;
a process for said innovative computer programs and software to instruct and cause said processor units and memories to process and translate said submitted individual categories in patients' languages into individual categories related to physicians which are integral components of health, health-care and health-care-service information and data on and related to patients being used by and among physicians of all and diverse medical and surgical practices or specialties for and in the communications of said information and data among physicians;
a process for said innovative computer programs and software to cause said processor units and memories to scan and check said individual categories related to physicians with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to physicians and patients adaptable to be continually displayed said matched and relations in said viewing screens of and among said devices and servers and platforms being used by and among patients and physicians;
a process for said innovative computer programs and software to cause said processor units and memories to scan and check said individual categories with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to human illnesses related to physicians and patients adaptable to be continually displayed said matched and relations in said viewing screens of and among said devices and servers and platforms being used by and among patients and physicians;
a process for said innovative computer programs and software to cause said processor units and memories to scan and check said individual categories with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to individual sequences or portions of DNA of human genome related to physicians and patients adaptable to be continually displayed said matched and relations in said viewing screens of and among said devices and servers and platforms being used by and among patients and physicians;
a process for said innovative computer programs and software to cause said processor units and memories to automatically translate said outcomes of said processes into languages comprehensible by patients adaptable to be displayed in the viewing screens of said devices being used by and among said patients;
a process for displaying said individual outcomes and related relations of said individual matches, scrutinies and scan and checks by said processor units and memories, Web server and Web browsers in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians; and
a process for said innovative computer programs and software to cause said processor units and memories to automatically and continually improve or optimize said outcomes of said processes related to physicians and patients and output said outcomes to, to be related and compiled in said SQL databases adaptable to be displayed in said viewing screens in said devices and platforms being used by and among patients and physicians.

7. The method according to claim 3 wherein said process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as said second SQL information and data, fourth, comprises:
a process for said innovative computer programs and software to cause said processor units and memories to generate relations of individual categories in patients' languages related to individual patients, individual groups of patients and physicians or individual group of physicians submitted by said individual patients and/or individual physicians or individual group of physicians using said devices to said processor units and memories;
a process for said innovative computer programs and software to instruct and cause said processor units and memories to process and translate said submitted individual categories in patients' languages into individual categories related to physicians which are integral components of health, health-care and health-care-service information and data on and related to patients being used by and among physicians of all and diverse medical and surgical practices or specialties for and in the communications of said information and data among physicians;
a process for said innovative computer programs and software to cause said processor units and memories to scan and check said individual categories related to physicians with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to physicians and patients adaptable to be continually displayed said matched and relations in said viewing screens of and among said devices and servers and platforms being used by and among patients and physicians;
a process for said innovative computer programs and software to cause said processor units and memories to scan and check said individual categories with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to human illnesses related to physicians and patients adaptable to be continually displayed said matched and relations in said viewing screens of and among said devices and servers and platforms being used by and among patients and physicians;
a process for said innovative computer programs and software to cause said processor units and memories to scan and check said individual categories with said relational information and data in and among said related SQL tables and repetitively match said individual categories and individual diagnoses and syndromes with same, similar or equivalent with same, similar or equivalent individual categories related to individual diagnoses and/or individual syndromes related to said physicians related to individual groups of related diagnoses and/or syndromes and related categories related to genetics related to physicians and patients adaptable to be continually displayed said matched and relations in said viewing screens of and among said devices and servers and platforms being used by and among patients and physicians;
a process for said innovative computer programs and software to cause said processor units and memories to automatically translate said outcomes of said processes into languages comprehensible by patients adaptable to be displayed in the viewing screens of said devices and platforms being used by and among said patients;
a process for displaying said individual outcomes and related relations of said individual matches, scrutinies and scan and checks by said processor units and memories, Web server and Web browsers in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians; and
said process for said innovative computer programs and software to cause said processor units and memories to automatically and continually improve or optimize said outcomes of said processes related to physicians and patients and output said outcomes to, to be related and compiled in said SQL databases adaptable to be displayed in said viewing screens in said devices and platforms being used by and among patients and physicians.

8. The method according to claim 3 wherein said process for displaying said individual outcomes and related relations of said individual scans, checks and matches, scrutinies, scans and checks by said processor units and memories, Web server and Web browsers in said viewing screens in said devices and platforms being used by and among said patients and physicians comprises:
a process for said innovative computer programs and software instruct and cause said processor units and memories to repetitively and continually scrutinize or scan and check individual adaptable relations of said second SQL information and data related to individual patients and physicians in said SQL databases with same, similar or equivalent SQL information and data related to patients and physicians in said first SQL information and data in said SQL databases wherein said individual outcomes of said individual scrutinies or scans and checks are outputted as second SQL information and data related to and compiled with expanding and improving said first adaptable SQL information and data in said SQL databases; and
a process for said innovative computer programs and software and various commercial programs and software, Web browsers, Web server and computer software for technologically pushing, pulling, forwarding, disseminating, sharing and streaming said outcomes of said processes to be technologically and continually push, pull, forward, disseminate, share and stream said second adaptable SQL information and data related to said first adaptable SQL information and data in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients and physicians.

9. The method according to claim 3 wherein said process for said innovative computer programs and software to cause said processor units and memories to automatically and continually improve or optimize said outcomes of said processes related to physicians and patients and output said outcomes to, to be related and compiled in said SQL databases adaptable to be displayed in said viewing screens in said devices and platforms being used by and among patients and physicians comprises:
said process for said network or networks to continually execute and achieve health-care continuities and vigilance and preventive medicine for and among individual patients and groups of patients and physicians by and among said computer servers, devices, physicians and patients;
said process for displaying said individual outcomes and related relations of said individual scans, checks and matches, scrutinies, scans and checks by said processor units and memories, Web server and Web browsers in said viewing screens in said devices and platforms being used by and among said patients and physicians; and
a process for said innovative computer programs and software to instruct and cause said processor units and memories to automatically and continually update, adapt, improve or optimize successive relations and compilations of said first adaptable SQL information and data to which related said second adaptable SQL information and data are automatically and continually scrutinized, scanned, checked and matched by said processor units and memories and related relations are outputted as second SQL information and data to and to be related and compiled with said first adaptable SQL information and data in and among said SQL tables in said SQL databases adaptable to be continually displayed in said viewing screens of and among said devices and servers and platforms being used by and among patients and physicians.

10. The method according to claim 3 wherein said process for said innovative computer programs and software to instruct and cause said processor units and memories to automatically and continually update, adapt and improve successive compilations of said first adaptable SQL information and data in said SQL databases adaptable to be displayed in said viewing screens in said devices and platforms being used by and among patients and physicians comprises:
said process for said innovative computer programs and software to instruct and cause said processor units and memories to repetitively scan and check said individual categories related to individual patients and physicians with said relational information and data in and among said related SQL tables and repetitively match said individual categories with same, similar or equivalent individual categories related to individual diagnoses or syndromes related to individual groups of related diagnoses and/or syndromes and related categories related to patients and physicians wherein said individual outcomes of said individual matches and related relations are continually related and compiled in said SQL databases and for said innovative computer programs and software, Web browsers, Web server and computer software for technologically pushing, pulling, forwarding, disseminating, sharing and streaming said outcomes of said processes among said devices and servers to cause said outcomes related to patients and physicians of said processes to be technologically and continually push, pull, forward, disseminate, share and stream in said viewing screens and platforms wherein said outcomes are interactive with, editable and adaptable by and among said patients and physicians using said devices;
said process for said innovative computer programs and software to instruct and cause said processor units and memories to repetitively scan and check said individual diagnoses related to individual patients and physicians with said relational information and data in and among said related SQL tables and repetitively match said individual diagnoses with same, similar or equivalent individual diagnoses related to individual diagnoses or syndromes and related categories related to individual groups of related diagnoses and/or syndromes and related categories related to patients and physicians wherein said individual outcomes of said individual matches and related relations are continually related and compiled in said SQL databases and for said innovative computer programs and software, Web browsers, Web server and computer software for technologically pushing, pulling, forwarding, disseminating, sharing and streaming said outcomes of said processes among said devices and severs to cause said outcomes related to patients and physicians of said processes to be technologically and continually push, pull, forward, disseminate, share and stream in said viewing screens and platforms wherein said outcomes are interactive with, editable and adaptable by and among said patients and physicians using said devices;
said process for said innovative computer programs and software to instruct and cause said processor units and memories to repetitively and continually scrutinize or scan and check individual adaptable relations of second SQL information and data with first adaptable SQL information and data comprising said individual diagnoses or syndromes and related categories related to individual groups of related diagnoses and/or syndromes and related categories related to individual groups patients and individual groups of physicians in said SQL databases wherein said individual outcomes of said individual scrutinies or scan and checks are continually related and compiled in said SQL databases and displayed in said viewing screens of and among said devices and servers and platforms being used by and among patients and physicians;
said process for said innovative computer programs and software, Web browsers, Web server and computer software for technologically pushing, pulling, forwarding, disseminating, sharing and streaming said second adaptable SQL information and data and related said first adaptable SQL information and data in clinical and medical algorithms and clinically logical sequences and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and platforms being used by and among individual patients, patients and physicians which are interactive with and responsive to patients and physicians in said viewing screens of said devices and platforms being used by and among individual patients, patients and physicians for repetitively and continually updating, adapting and improving successive versions of SQL relations of said SQL information and data in and among said SQL tables in said SQL databases; and
a process for said innovative computer programs and software to instruct and cause said processor units and memories to repetitively and continually relate and compile said edited and adapted second adaptable SQL information in said first adaptable SQL information and data in said SQL databases.

11. The method according to claim 3 wherein said process for said network or networks to continually execute and achieve health-care continuities and vigilance and preventive medicine for and among individual patients and groups of patients and physicians by and among said computer servers, devices, physicians and comprises a process for said processor units and memories to repetitively and continually:
i. determine congruencies of and detect human illnesses and clinical and biological deviations including errors, mistakes, irregularities, illogics, complications, risks and sequelae in said SQL relations in individual second adaptable SQL information and data related to said SQL relations in said first adaptable SQL information and data adaptable to be displayed in said viewing screens of said devices and platforms being used by patients and physicians;
ii. determine redundancies and duplications in said SQL relations in individual second adaptable SQL information and data related to said SQL relations in said first adaptable SQL information and data adaptable to be displayed in said viewing screens of said devices and platforms being used by patients and physicians; and
iii. extrapolate and forecast clinical and medical trends, processes, risks, complications, errors, mistakes, consequences, sequelae, time-courses and morbidity and mortality in and related to said SQL relations in individual second adaptable SQL information and data related to said SQL relations in said first adaptable SQL information and data adaptable to be displayed in clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and servers and platforms being used by and among individual patients, patients and physicians.

12. The method according to claim 3 wherein said process for said network or networks to continually execute and achieve health-care continuities and vigilance and preventive medicine for and among individual patients and groups of patients and physicians by and among said computer servers, devices, physicians and patients comprises a process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians.

13. The process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians according to claim 12 comprises:
a process for said innovative computer programs and software to cause said processor units and memories to generate relations and compilations of related said individual categories and, if related, related to individual said human illnesses, and if related, related to individual said genetics related to diagnoses and syndromes including synonyms, acronyms and equivalences related to patients and physicians and outputting said relations and compilations to, to be related and compiled in said first SQL information and data in said SQL databases; and
said process for said innovative computer programs and software to instruct and cause said processor units and memories to repetitively scan and check said individual categories or individual diagnoses or syndromes with said second SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as second SQL information and data to and to be related and compiled with said first adaptable SQL information and data in and among said SQL tables in said SQL databases adaptable to be continually displayed in said viewing screens of and among said devices and servers and platforms being used by and among patients and physicians; and
a process for said innovative computer programs and software to instruct and cause said processor units and memories to repetitively and continually scrutinize or scan and check individual said second SQL information and data with said first adaptable SQL information and data and match said second adaptable SQL information and data with same, similar or equivalent said individual categories and/or individual diagnoses and/or syndromes and/or individual groups of diagnoses and/or syndromes in said first adaptable SQL information and data wherein said individual outcomes of said individual scrutinies, scans, checks and matches are continually outputted to and related and compiled in and among said SQL tables in said first adaptable SQL databases adaptable to be displayed in said viewing screens of and among said devices and servers and platforms being used by and among patients and physicians.
a process for said innovative computer programs and software and, Web browsers, Web server and commercial programs and software for technologically pushing, pulling, forwarding, disseminating, sharing and streaming said information and data to technologically push, pull, forward, disseminate, share and stream said SQL relations of related said individual categories and, if related, related individual said human illnesses, and if related, related individual said genetics and related diagnoses and syndromes related to patients and physicians in said first SQL information and data in said SQL databases as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians; and
a process for said innovative computer programs and software and, Web browsers, Web server and commercial programs and software for technologically pushing, pulling, forwarding, disseminating, sharing and streaming to technologically push, pull, forward, disseminate, share and stream said SQL relations of said second adaptable SQL information and data related to individual patients and physicians and said first SQL information and data in said SQL databases as clinical and medical algorithms and clinically logical sequences and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians.

14. In a system for delivering health-care continuities and vigilance and preventive medicine for individual patients, groups of patients and physicians by and among computer servers and computers, laptops, computer tablets, mobile and wireless communication devices henceforth devices and said platforms and physicians and patients using said devices in said system comprising a network or networks of said servers, devices, platforms and physicians and patients, a method for applying individual constellations and continua of related diagnoses and syndromes and related individual categories and related occurrences, causes, developments, progressions and events of related acute, subacute and chronic diseases, disorders and illnesses in the viewing screens for delivering health-care continuities and vigilance and preventive medicine for and among physicians and patients by said network or networks of said servers, devices, platforms and physicians and patients comprises:
a process for operating said functioning and operating said network or networks of said servers comprising said innovative computer programs and software including stored procedures and various commercial computer programs and software coupled to said processor units and memories and at least a Web server and devices and platforms comprising viewing screens including touch-screens and Web browsers being used by and among said physicians and patients;
a process for said innovative computer programs and software to cause said processor units and memories to generate first adaptable SQL information and data comprising relations and compilations of related diagnoses and/or syndromes including synonyms, acronyms and equivalences and related signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories or categories and related to individual acute, subacute or chronic diseases, disorders and/or illnesses including acute, subacute and chronic infections and related epidemiologies, chronologies and time-courses and physiological, immunological and clinical processes and responses and related clinical and biological processes, patterns, trends, complications, risks, sequelae henceforth human illnesses and related clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related to individual medical and/or surgical specialties by said patients and physicians using said devices to said processor units and memories which process relational information and data and output said relations and compilations to and to be related to SQL keys in said SQL tables in said SQL databases according to said innovative computer programs and software;
a process for said innovative computer programs and software to cause said processor units and memories to generate relations of individual categories related to individual patients and physicians or individual group of physicians submitted by said individual physicians or individual group of physicians using said devices to said processor units and memories;
a process for said innovative computer programs and software to cause said processor units and memories to generate relations of individual diagnoses or syndromes related to individual patients and physicians or individual group of physicians submitted by said individual physicians or individual group of physicians using said devices to said processor units and memories;
a process for said innovative computer programs and software to cause said processor units and memories to generate relations of individual categories in patients' languages related to individual patients and physicians or individual group of physicians submitted by said individual patients and/or individual physicians or individual group of physicians using said devices to said processor units and memories;
a process for said innovative computer programs and software to cause said processor units and memories to generate relations of individual categories in patients' languages related to individual patients, individual groups of patients and physicians or individual group of physicians submitted by said individual patients and/or individual physicians or individual group of physicians using said devices to said processor units and memories;
a process for said innovative computer programs and software including stored procedures to instruct and cause said processor units and memories to generate and compile said relational information and data in related SQL tables in said SQL databases;
a process for translating said submitted individual categories in patients' languages by said individual patients or individual groups of patients into individual categories related to physicians which are integral components of health, health-care and health-care-service information and data on and related to patients being used by and among physicians of all and diverse medical and surgical practices or specialties for and in the communications of said information and data by and among physicians by said processor units and memories;
a process for said innovative computer programs and software to instruct and cause said processor units and memories to repetitively scan and check said individual categories or individual diagnoses or syndromes with said SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as second SQL information and data comprising individual categories and/or individual diagnoses or syndromes or individual groups of diagnoses and/or syndromes and related categories related to individual groups of related diagnoses and/or syndromes and related categories and, if related, related human illnesses and genetics related to individual patients and physicians in said SQL databases and to be related and compiled with SQL information and data in and among said SQL tables in said SQL databases and continually displayed in said viewing screens of and among said devices and servers and platforms being used by and among patients and physicians;
a process for said innovative computer programs and software to instruct and cause said processor units and memories to repetitively and continually scrutinize or scan and check individual adaptable relations of SQL information and data comprising individual diagnoses or syndromes and related categories related to individual groups of related diagnoses and/or syndromes and related categories related to individual patients and physicians in said SQL databases with same, similar or equivalent SQL information and data related to patients and physicians in said SQL databases wherein said individual outcomes of said individual scrutinies or scan and checks are continually displayed in said viewing screens of and among said devices and servers and platforms being used by and among patients and physicians;
a process for translating said outcomes of said processes into languages comprehensible by patients adaptable to be displayed in the viewing screens of said devices by said processor units and memories;
a process for said innovative computer programs and software instruct and cause said processor units and memories to repetitively and continually scrutinize or scan and check individual adaptable relations of said second SQL information and data related to individual patients and physicians in said SQL databases with same, similar or equivalent SQL information and data related to patients and physicians in said first SQL information and data in said SQL databases wherein said individual outcomes of said individual scrutinies or scans and checks are outputted as second SQL information and data related to and compiled with expanding and improving said first adaptable SQL information and data in said SQL databases;
a process for displaying said information and data and related individual outcomes and related relations of said individual scans, checks and matches, scrutinies, scans and checks by said processor units and memories, Web server and Web browsers in said viewing screens of said devices and platforms being used by and among individual patients, patients and physicians;
a process for said innovative computer programs and software to instruct and cause said processor units and memories to automatically and continually update, adapt and improve successive compilations of said first adaptable SQL information and data and adaptable SQL information and data in said SQL databases adaptable to be displayed in said viewing screens in said devices and platforms being used by and among patients and physicians;
a process for said network or networks to continually execute and achieve health-care continuities and vigilance and preventive medicine for and among individual patients and groups of patients and physicians by and among said computer servers, devices, physicians and patients; and
a process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians.

15. The method according to claim 14 wherein said process for said network or networks to continually execute and achieve health-care continuities and vigilance and preventive medicine for and among individual patients and groups of patients and physicians by and among said computer servers, devices, physicians and comprises a process for said processor units and memories to repetitively and continually:
i. determine congruencies of and detect human illnesses and clinical and biological deviations including errors, mistakes, irregularities, illogics, complications, risks and sequelae in said SQL relations in individual second adaptable SQL information and data related to said SQL relations in said first adaptable SQL information and data adaptable to be displayed in said viewing screens of said devices and platforms being used by patients and physicians;
ii. determine redundancies and duplications in said SQL relations in individual second adaptable SQL information and data related to said SQL relations in said first adaptable SQL information and data adaptable to be displayed in said viewing screens of said devices and platforms being used by patients and physicians; and
iii. extrapolate and forecast clinical and medical trends, processes, risks, complications, errors, mistakes, consequences, sequelae, time-courses and morbidity and mortality in and related to said SQL relations in individual second adaptable SQL information and data related to said SQL relations in said first adaptable SQL information and data adaptable to be displayed in clinical and medical algorithms and clinically logical sequences, orders and arrays of said related diagnoses and related categories and, if related, related human illnesses and/or related genetics and related clinical reasons, presentations, documents, illustrations and arguments supporting said algorithms and clinically logical sequences and arrays comprehensible by and interactive with and responsive to patients and physicians in said viewing screens of said devices and servers and platforms being used by and among individual patients, patients and physicians.

16. The method according to claim 14 wherein said process for said network or networks to continually execute and achieve health-care continuities and vigilance and preventive medicine for and among individual patients and groups of patients and physicians by and among said computer servers, devices, physicians and patients comprises a process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians.

17. The process for said network or networks to compile and generate individual continua of SQL relations of said first adaptable SQL information and data and related second adaptable SQL information and data in said SQL databases adaptable to be displayed in said viewing screens and platforms for delivering health-care continuities and vigilance and preventive medicine for and among individual patients, groups of patients and physicians in said network or networks of computer servers, devices and said patients and physicians according to claim 16 comprises:
a process for said innovative computer programs and software to cause said processor units and memories to generate relations and compilations of related said individual categories and, if related, related to individual said human illnesses, and if related, related to individual said genetics related to diagnoses and syndromes including synonyms, acronyms and equivalences related to patients and physicians and outputting said relations and compilations to, to be related and compiled in said first SQL information and data in said SQL databases; and
said process for said innovative computer programs and software to instruct and cause said processor units and memories to repetitively scan and check said individual categories or individual diagnoses or syndromes with said second SQL information and data in and among said SQL tables and repetitively match said individual categories or individual diagnoses or syndromes with same, similar or equivalent individual categories related to individual diagnoses or syndromes related to individual groups of related diagnoses and/or syndromes and related categories or with same, similar or equivalent individual diagnoses or syndromes related to individual categories related to individual diagnoses or syndromes related categories, respectively, wherein said individual outcomes of said individual matches and related relations are outputted as second SQL information and data to and to be related and compiled with said first adaptable SQL information and data in and among said SQL tables in said SQL databases adaptable to be continually displayed in said viewing screens of and among said devices and servers and platforms being used by and among patients and physicians; and
a process for said innovative computer programs and software to instruct and cause said processor units and memories to repetitively and continually scrutinize or scan and check individual said second SQL information and data with said first adaptable SQL information and data and match said second adaptable SQL information and data with same, similar or equivalent said individual categories and/or individual diagnoses and/or syndromes and/or individual groups of diagnoses and/or syndromes in said first adaptable SQL information and data wherein said individual outcomes of said individual scrutinies, scans, checks and matches are continually outputted to and related and compiled in and among said SQL tables in said first adaptable SQL databases adaptable to be displayed in said viewing screens of and among said devices and servers and platforms being used by and among patients and physicians.
a process for said innovative computer programs and software and, Web browsers, Web server and commercial programs and software for technologically pushing, pulling, forwarding, disseminating, sharing and streaming said information and data to technologically push, pull, forward, disseminate, share and stream said SQL relations of related said individual categories and, if related, related individual said human illnesses, and if related, related individual said genetics and related diagnoses and syndromes related to patients and physicians in said first SQL information and data in said SQL databases as clinical and medical algorithms and clinically logical sequences, orders and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians; and
a process for said innovative computer programs and software and, Web browsers, Web server and commercial programs and software for technologically pushing, pulling, forwarding, disseminating, sharing and streaming to technologically push, pull, forward, disseminate, share and stream said SQL relations of said second adaptable SQL information and data related to individual patients and physicians and said first SQL information and data in said SQL databases as clinical and medical algorithms and clinically logical sequences and arrays of said related diagnoses and syndromes and related categories and, if related, related human illnesses and/or related genetics and related clinical reasons and clinically ordered and structured presentations, documents, illustrations and arguments supporting said algorithms and sequences and arrays comprehensible by and interactive with and responsive to patients and physicians in said viewing screens of said devices and platforms being used by and among individual patients, patients and physicians.
